(19) United States
(12) Patent Application Publication
(10) Pub. No.: US 2026/0160918 A1
(43) Pub. Date: Jun. 11, 2026

(54) METAL DETECTOR

(71) Applicant: SHANGHAI TIANXUN ELECTRONIC EQUIPMENT CO.,LTD, SHANGHAI (CN)

(72) Inventor: DAOXING GONG, SHANGHAI (CN)

(21) Appl. No.: 19/001,590

(22) Filed: Dec. 26, 2024

(30) Foreign Application Priority Data
Dec. 6, 2024 (CN) 202411802205.1

(51) Int. Cl. G01V 3/165

(52) U.S. Cl. CPC G01V 3/165

(57) ABSTRACT

A metal detector is provided, including a detection coil, a telescopic assembly, cam locking mechanisms, a handle, and an arm brace. The detection coil is rotatably connected to and lockable to a bottom portion the telescopic assembly, the cam locking mechanisms are disposed on an outer side of the telescopic assembly and are configured to block a length of the telescopic assembly, the arm brace is slidably disposed at an upper portion of the handle. The metal detector is composed of five parts, the telescopic assembly is capable of rotating and locking relative to the detection coil while extending and retracting. Moreover, a position of the arm brace is also adjustable relative to the telescopic assembly, thereby enabling multi-angle adjustments on angle, length, and grip position of the metal detector, so as to improve convenience and flexibility of use of the metal detector.

### TECHNICAL FIELD

The present disclosure relates to a technical field of metal detectors, and in particular to a metal detector.

### BACKGROUND

Metal detectors are devices for detecting metal objects, a working principle of which is based on response of metals to electromagnetic fields. When each metal detector approaches a corresponding metal object, a magnetic field within each metal detector changes, thereby triggering each metal detector to emit an alarm or indication signal.

Current metal detectors each typically includes a device, such as an electromagnetic coil, for generating a magnetic field, a sensor for detecting a change in the magnetic field, and a signal processor. When one metal object enters a detecting range of a corresponding metal detector, the one metal object may interfere with a magnetic field generated by the corresponding metal detector, thereby changing the magnetic field. The sensor is configured to capture such change in the magnetic field and convert the change to an electrical signal for the signal processor to process, so that the corresponding metal detector finally triggering an alarm or display a location of the one metal object.

After research, it is found that Chinese patent publication No. CN209656903U discloses a metal detector, including a metal probe, a display module, a circuit board, a main housing, a battery compartment, a sealed bottom cover, metal detector buttons, and a soft rubber body. The metal probe, the display module, and the circuit board are disposed in the main housing, the metal probe is connected to the circuit board, the display module is connected to the circuit board, the metal detector buttons are disposed in the hollowed-out portions of the main housing, the battery compartment is disposed at a tail end of the main housing, while the other end of the main housing is connected to the sealed bottom cover, and the soft rubber body is in close contact with the main housing.

The Chinese patent publication No. CN209656903U has defects that the metal detector cannot achieve multi-angle adjustments on angle, length, and grip position, thereby limiting usability thereof.

### SUMMARY

The present disclosure aims to provide a metal detector to overcome defects in the prior art.

In order to achieve above aims, the present disclosure adopts following technical solutions.

The present disclosure provides the metal detector, including a detection coil, a telescopic assembly, cam locking mechanisms, a handle, and an arm brace. The detection coil is rotatably connected to and lockable to a bottom portion the telescopic assembly, the cam locking mechanisms are disposed on an outer side of the telescopic assembly and are configured to block a length of the telescopic assembly, the arm brace is slidably disposed at an upper portion of the handle, the handle partially extends through an interior of the arm brace, and the arm brace is locked to an outer wall of the handle through a corresponding one of the cam locking mechanisms.

Furthermore, the telescopic assembly includes a lower shaft, a middle shaft, and an upper shaft. The lower shaft, the middle shaft, and the upper shaft are slidably connected in sequence. An end cap is disposed at a top end of the handle.

Furthermore, the lower shaft, the middle shaft, and the upper shaft are made of aluminum tubing or carbon fiber tubing. A cross section of the lower shaft, a cross section of the middle shaft, a cross section of the lower shaft, and a cross section of the handle are non-circular.

Furthermore, the cam locking mechanisms includes connecting sleeves, pressing pieces, and cam locking levers. Two of the connecting sleeves are respectively fixed to an outer wall of the middle shaft and an outer wall of the upper shaft. Two first holes are respectively defined on the middle shaft and the upper shaft, two second holes are respectively defined on inner walls of the two of the connecting sleeves, the two first holes and the two second holes cooperate to respectively accommodate corresponding two of the pressing pieces. A first end of each of corresponding two of the cam locking levers is connected to an outer wall of a corresponding one of the two of the connecting sleeves through a positioning pin, a second end of each of the corresponding two of the cam locking levers is in contact with and limited at an outer side end surface of the corresponding one of the two of the connecting sleeves. Inner side end surfaces of the two of the connecting sleeves are respectively in contact and matched and the outer wall of the middle shaft and the outer wall of the upper shaft. Two third holes are respectively defined on an inner wall of the middle shaft and an inner wall of the upper shaft, the two of the connecting sleeves respectively include two first protrusions on two bottom portions thereof, the two first protrusions are respectively matched with the two third holes.

Furthermore, three anti-disengagement components are respectively disposed at a top end of the lower shaft, a top end of the middle shaft, and a top end of the upper shaft, the top end of the lower shaft, the top end of the middle shaft, and the top end of the upper shaft respectively define three fourth holes, three second protrusions are respectively disposed on inner walls of the three anti-disengagement components, and the three second protrusions are respectively matched with the three fourth holes.

Furthermore, the lower shaft includes a carbon fiber shaft and a shaft connector, the shaft connector is movably inserted into an inner wall of the carbon fiber shaft, and the shaft connector is fixed to the carbon fiber shaft through at least one positioning clamping column.

Furthermore, a first through hole is defined at an end portion of the shaft connector, second through holes are respectively defined at one side of the detection coil, a locking screw passes through the first through hole and the second through holes, a locking nut is threadedly connected to an end portion of the locking screw, and silicone gaskets are respectively disposed between the one side of the detection coil where the second through holes are defined and the end portion of the shaft connector where the first through hole is defined.

Furthermore, a positioning hole is defined on an inner wall of the handle, a controller is disposed on an inner wall of the positioning hole. The controller includes a user operation interface, a loudspeaker, a headphone jack, a battery, a processor, an operation panel, and a port for connecting to the detection coil. A bottom portion of the handle defines a positioning sliding groove, the positioning sliding groove is configured to accommodate an auxiliary power supply box.

Furthermore, the handle includes a grip at one side thereof, a fixing platform is inserted into one side of the grip.

Furthermore, a strap and a probe rod positioning piece are disposed on an outer wall of the arm brace.

Beneficial effects of the present disclosure are as following.

The metal detector is composed of five parts, the telescopic assembly is capable of rotating and locking relative to the detection coil while extending and retracting. Moreover, a position of the arm brace is also adjustable relative to the telescopic assembly, thereby enabling multi-angle adjustments on angle, length, and grip position of the metal detector, so as to improve convenience and flexibility of use of the metal detector.

### BRIEF DESCRIPTION OF DRAWINGS

FIG. 1 is a three-dimensional schematic diagram of a metal detector of the present disclosure.

FIG. 2 is a side schematic diagram of the metal detector in an extension state.

FIG. 3 is a side schematic diagram of the metal detector in a contracted state.

FIG. 4 is an exploded schematic diagram of the metal detector.

FIG. 5 is an installation schematic diagram of a fixing platform of the metal detector.

FIG. 6 is an exploded assembly schematic diagram of a lower shaft of the metal detector.

FIG. 7 is a side cross-sectional schematic diagram of the metal detector.

FIG. 8 is a schematic diagram illustrating hole positions of a telescopic assembly of the metal detector.

FIG. 9 is an assembly schematic diagram of an three anti-disengagement component.

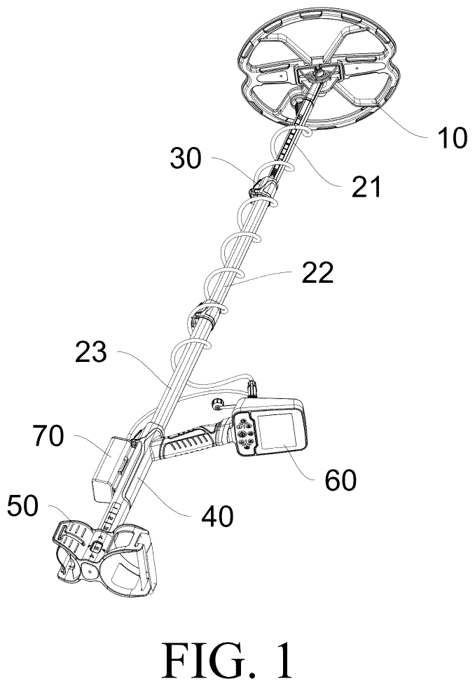

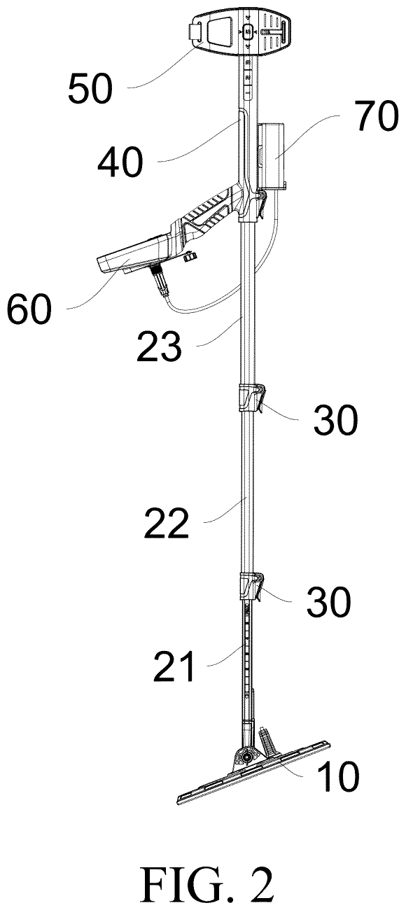

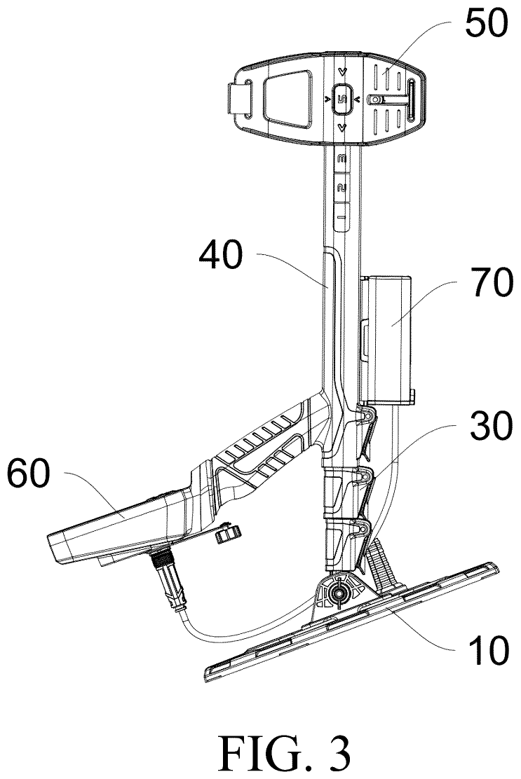

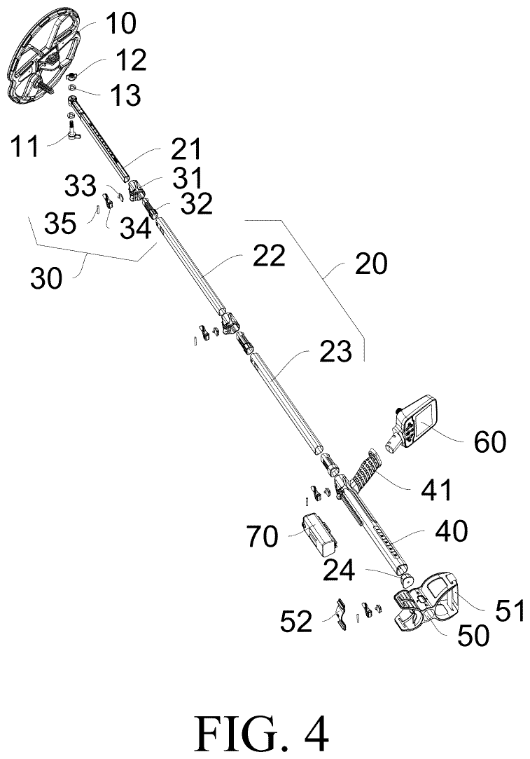

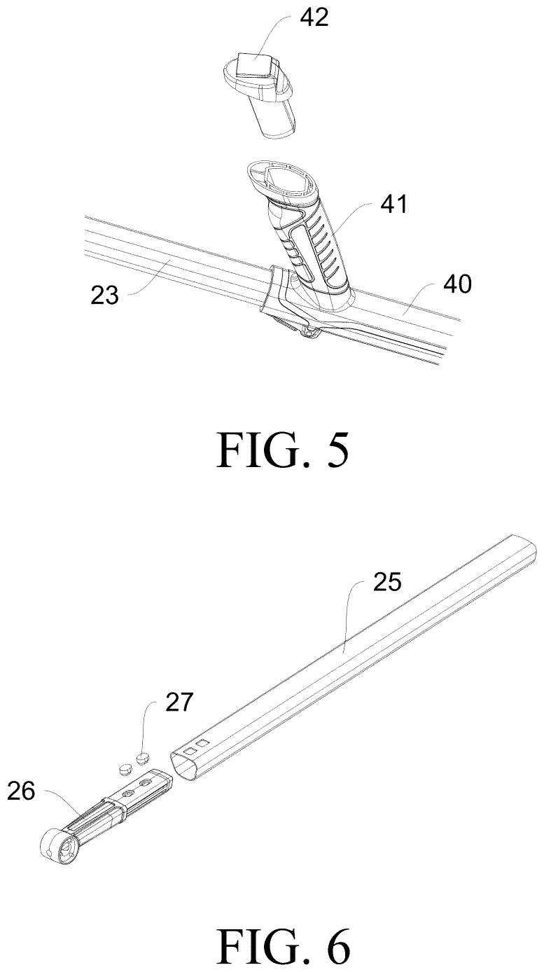

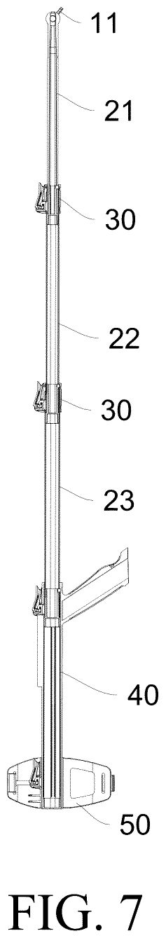

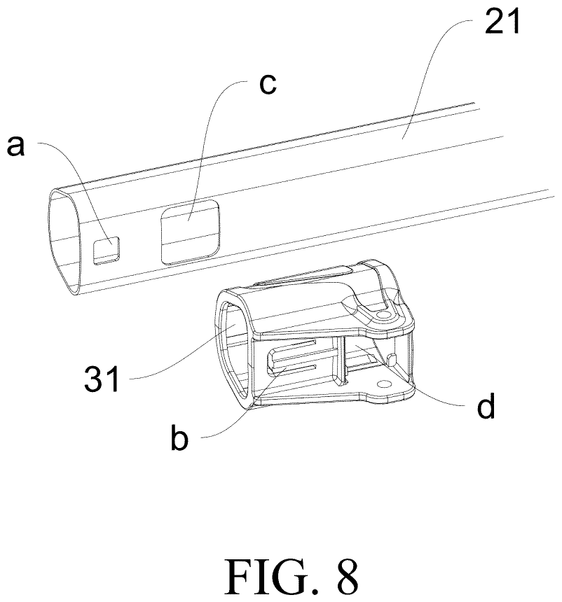

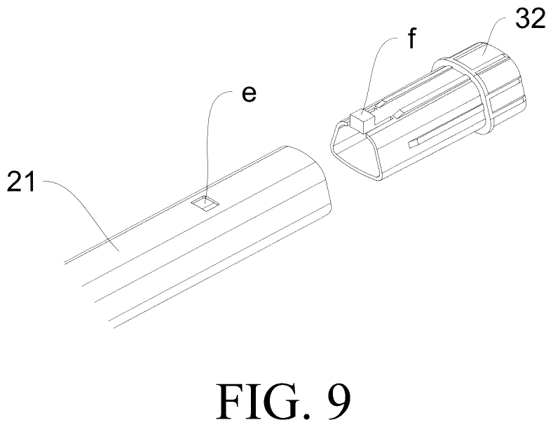

Reference numerals in the drawings: 10. detection coil; 11. locking screw; 12. locking nut; 13. silicone gasket; 20. telescopic assembly; 21. lower shaft; 22. middle shaft; 23. upper shaft; 24. end cap; 25. carbon fiber shaft; 26. shaft connector; 27. positioning clamping column; 30. cam locking mechanism; 31. connecting sleeve; 32. anti-disengagement component; 33. pressing piece; 34. cam locking lever; 35. positioning pin; 40. handle; 41. grip; 42. fixing platform; 50. arm brace; 51. strap; 52. probe rod positioning piece; 60. controller; 70. auxiliary power supply box

### DETAILED DESCRIPTION OF EMBODIMENTS

Technical solutions of the present disclosure are further described in detail below with reference to specific embodiments.

Embodiments of the present disclosure are described in detail below, and examples of the embodiments are shown in accompanying drawings, in which the same or similar reference numerals refer to the same or similar components or components with the same or similar functions throughout. The embodiments described below with reference to the accompanying drawings are exemplary and are merely used to explain the present disclosure, and should not be construed as limiting the present disclosure.

### First Embodiment

The present disclosure provides a metal detector, including a detection coil 10, a telescopic assembly 20, cam locking mechanisms 30, a handle 40, and an arm brace 50. The detection coil 10 is rotatably connected to and lockable to a bottom portion the telescopic assembly 20, the cam locking mechanisms 30 are disposed on an outer side of the telescopic assembly 20 and are configured to block a length of the telescopic assembly 20, the arm brace 50 is slidably disposed at an upper portion of the handle 40, the handle 40 partially extends through an interior of the arm brace 50, and the arm brace 50 is locked to an outer wall of the handle 40 through a corresponding one of the cam locking mechanisms 30.

During use, the length of the telescopic assembly 20 is adjusted according to a height condition and usage habits of a user, so that an overall length of the metal detector is adjusted, after adjusting the length of the telescopic assembly 20, the telescopic assembly 20 is locked through the cam locking mechanisms 30, then a position of the arm brace 50 is adjusted, and after adjusting the position of the arm brace 50, one hand of the user cooperates with the arm brace 50 to perform metal detection.

The telescopic assembly 20 includes a lower shaft 21, a middle shaft 22, and an upper shaft 23. The lower shaft 21, the middle shaft 22, and the upper shaft 23 are slidably connected in sequence. An end cap 24 is disposed at a top end of the handle 40.

The lower shaft 21, the middle shaft 22, and the upper shaft 23 are made of aluminum tubing or carbon fiber tubing. A cross section of the lower shaft 21, a cross section of the middle shaft 22, a cross section of the lower shaft 23, and a cross section of the handle 40 are non-circular.

The cam locking mechanisms 30 includes connecting sleeves 31, pressing pieces 33, and cam locking levers 34. Two of the connecting sleeves 31 are respectively fixed to an outer wall of the middle shaft 22 and an outer wall of the upper shaft 23. Two first holes c are respectively defined on the middle shaft 22 and the upper shaft 23, two second holes d are respectively defined on inner walls of the two of the connecting sleeves 31, the two first holes d and the two second holes c cooperate to respectively accommodate corresponding two of the pressing pieces 33. A first end of each of corresponding two of the cam locking levers 34 is connected to an outer wall of a corresponding one of the two of the connecting sleeves 31 through a positioning pin 35, a second end of each of the corresponding two of the cam locking levers 34 is in contact with and limited at an outer side end surface of the corresponding one of the two of the connecting sleeves 31. Inner side end surfaces of the two of the connecting sleeves 31 are respectively in contact and matched and the outer wall of the middle shaft 22 and the outer wall of the upper shaft 23.

Two third holes a are respectively defined on an inner wall of the middle shaft 22 and an inner wall of the upper shaft 23, the two of the connecting sleeves 31 respectively include two first protrusions b on two bottom portions thereof, the two first protrusions b are respectively matched with the two third holes a.

When the corresponding two of the cam locking levers 34 rotate, the two of the connecting sleeves 31 are pressed by protruding portions of the corresponding two of the cam locking lever 34, so that the two of the connecting sleeves 31 are respectively in close contact with the lower shaft 21 and the middle shaft 22, the lower shaft 21, the middle shaft 22, and the upper shaft 23 are fixed with each other through friction.

Three anti-disengagement components 32 are respectively disposed at a top end of the lower shaft 21, a top end of the middle shaft 22, and a top end of the upper shaft 23, the top end of the lower shaft 21, the top end of the middle shaft 22, and the top end of the upper shaft 23 respectively define three fourth holes e, three second protrusions f are respectively disposed on inner walls of the three anti-disengagement components 32, and the three second protrusions are respectively matched with the three fourth holes. The three second protrusions f respectively at front ends of the three anti-disengagement components 32 are respectively limited in the connecting sleeves 31, so as to prevent the lower shaft 21, the middle shaft 22, the upper shaft 23, and the handle 40 from sliding off. Specifically, the anti-disengagement components 32 are configured to fill gaps respectively between the lower shaft 21, the middle shaft 22, the upper shaft 23, and the handle 40, thereby preventing or at least minimizing any relative movement or wobbing between the lower shaft 21, the middle shaft 22, the upper shaft 23, and the handle 40.

A positioning hole is defined on an inner wall of the handle 40, a controller 60 is disposed on an inner wall of the positioning hole. The controller 60 includes a user operation interface, a loudspeaker, a headphone jack, a battery, a processor, an operation panel, and a port for connecting to the detection coil 10.

A bottom portion of the handle 40 defines a positioning sliding groove, the positioning sliding groove is configured to accommodate an auxiliary power supply box 70.

The handle 40 includes a grip 41 at one side thereof, a fixing platform 42 is inserted into one side of the grip 41.

A strap 51 and a probe rod positioning piece 52 are disposed on an outer wall of the arm brace 50.

The lower shaft 21 includes a carbon fiber shaft 25 and a shaft connector 26, the shaft connector 26 is movably inserted into an inner wall of the carbon fiber shaft 25, and the shaft connector 26 is fixed to the carbon fiber shaft 25 through at least one positioning clamping column 27.

A first through hole is defined at an end portion of the shaft connector 26, second through holes are respectively defined at one side of the detection coil 10, a locking screw 11 passes through the first through hole and the second through holes, a locking nut 12 is threadedly connected to an end portion of the locking screw 11, and silicone gaskets 13 are respectively disposed between the one side of the detection coil 10 where the second through holes are defined and the end portion of the shaft connector 26 where the first through hole is defined.

During use, the length of the telescopic assembly 20 is adjusted according to the height condition and the usage habits of the user, so that the overall length of the metal detector is adjusted, after adjusting the length of the telescopic assembly 20, the telescopic assembly 20 is locked through the cam locking mechanisms 30, then the position of the arm brace 50 is adjusted, and after adjusting the position of the arm brace 50, the one hand of the user cooperates with the arm brace 50 to perform the metal detection. When the corresponding two of the cam locking levers 34 rotate, the two of the connecting sleeves 31 are pressed by the protruding portions of the corresponding two of the cam locking lever 34, so that the two of the connecting sleeves 31 are respectively in close contact with the lower shaft 21 and the middle shaft 22, the lower shaft 21, the middle shaft 22, and the upper shaft 23 are fixed with each other through the friction. The three second protrusions f respectively at the front ends of the three anti-disengagement components 32 are respectively limited in the connecting sleeves 31, so as to prevent the lower shaft 21, the middle shaft 22, the upper shaft 23, and the handle 40 from sliding off. Specifically, the anti-disengagement components 32 are configured to fill the gaps respectively between the lower shaft 21, the middle shaft 22, the upper shaft 23, and the handle 40, thereby preventing or at least minimizing any relative movement or wobbing between the lower shaft 21, the middle shaft 22, the upper shaft 23, and the handle 40.

### Second Embodiment

The metal detector in the second embodiment is basically the same as the solution in first embodiment, and difference lies in that in the second embodiment, the controller 60 is not disposed in the positioning hole of the handle 40. On the contrary, the handle 40 includes a grip 41 at one side thereof, a fixing platform 42 is inserted into one side of the grip 41. The fixing platform 42 is an optional accessory for accommodating and fixing various models of controllers.

The foregoing are merely preferred embodiments of the present disclosure, a protection scope of the present disclosure is not limited thereto, and those who skilled in the art may make equivalent replacements or changes according to technical solutions of the present disclosure and an inventive concept thereof within a technical scope disclosed by the present disclosure, which should be within the protection scope of the present disclosure.

What is claimed is:

1. A metal detector, comprising:
a detection coil;
a telescopic assembly;
cam locking mechanisms;
a handle; and
an arm brace;
wherein the detection coil is rotatably connected to and lockable to a bottom portion the telescopic assembly, the cam locking mechanisms are disposed on an outer side of the telescopic assembly and are configured to block a length of the telescopic assembly, the arm brace is slidably disposed at an upper portion of the handle, the handle partially extends through an interior of the arm brace, and the arm brace is locked to an outer wall of the handle through a corresponding one of the cam locking mechanisms.

2. The metal detector according to claim 1, wherein the telescopic assembly comprises a lower shaft, a middle shaft, and an upper shaft;
the lower shaft, the middle shaft, and the upper shaft are slidably connected in sequence; and
an end cap is disposed at a top end of the handle.

3. The metal detector according to claim 2, wherein the lower shaft, the middle shaft, and the upper shaft are made of aluminum tubing or carbon fiber tubing; and
a cross section of the lower shaft, a cross section of the middle shaft, and a cross section of the lower shaft are non-circular.

4. The metal detector according to claim 2, wherein the cam locking mechanisms comprise connecting sleeves, pressing pieces, and cam locking levers;
two of the connecting sleeves are respectively fixed to an outer wall of the middle shaft and an outer wall of the upper shaft;
two first holes are respectively defined on the middle shaft and the upper shaft, two second holes are respectively defined on inner walls of the two of the connecting sleeves, the two first holes and the two second holes cooperate to respectively accommodate the two of the pressing pieces;
a first end of each of corresponding two of the cam locking levers is connected to an outer wall of a corresponding one of the two of the connecting sleeves through a positioning pin, a second end of each of the corresponding two of the cam locking levers is in contact with and limited at an outer side end surface of the corresponding one of the two of the connecting sleeves;
inner side end surfaces of the two of the connecting sleeves are respectively in contact and matched and the outer wall of the middle shaft and the outer wall of the upper shaft;
two third holes are respectively defined on an inner wall of the middle shaft and an inner wall of the upper shaft, the two of the connecting sleeves respectively comprise two first protrusions on two bottom portions thereof, the two first protrusions are respectively matched with the two third holes.

5. The metal detector according to claim 2, wherein three anti-disengagement components are respectively disposed at a top end of the lower shaft, a top end of the middle shaft, and a top end of the upper shaft, the top end of the lower shaft, the top end of the middle shaft, and the top end of the upper shaft respectively define three fourth holes, three second protrusions are respectively disposed on inner walls of the three anti-disengagement components, and the three second protrusions are respectively matched with the three fourth holes.

6. The metal detector according to claim 2, wherein the lower shaft comprises a carbon fiber shaft and a shaft connector, the shaft connector is movably inserted into an inner wall of the carbon fiber shaft, and the shaft connector is fixed to the carbon fiber shaft through at least one positioning clamping column.

7. The metal detector according to claim 6, wherein a first through hole is defined at an end portion of the shaft connector, second through holes are respectively defined at one side of the detection coil, a locking screw passes through the first through hole and the second through holes, a locking nut is threadedly connected to an end portion of the locking screw, and silicone gaskets are respectively disposed between the one side of the detection coil where the second through holes are defined and the end portion of the shaft connector where the first through hole is defined.

8. The metal detector according to claim 1, wherein a positioning hole is defined on an inner wall of the handle, a controller is disposed on an inner wall of the positioning hole;
the controller comprises a user operation interface, a loudspeaker, a headphone jack, a battery, a processor, an operation panel, and a port for connecting to the detection coil; and
a bottom portion of the handle defines a positioning sliding groove, the positioning sliding groove is configured to accommodate an auxiliary power supply box.

9. The metal detector according to claim 1, wherein the handle comprises a grip at one side thereof, a fixing platform is inserted into one side of the grip.

10. The metal detector according to claim 1, wherein a strap and a probe rod positioning piece are disposed on an outer wall of the arm brace.
